(19) United States
(12) Patent Application Publication
(10) Pub. No.: US 2011/0168671 A1
(43) Pub. Date: Jul. 14, 2011

(54) PROCESS CONTROL USING SIGNAL REPRESENTATIVE OF A THROTTLE VALVE POSITION

(75) Inventors: John M. Yamartino, Croton on Hudson, NY (US); Anthony D. Lisi, Poughkeepsie, NY (US)

(73) Assignee: INTERNATIONAL BUSINESS MACHINES CORPORATION, Armonk, NY (US)

(21) Appl. No.: 12/684,162

(22) Filed: Jan. 8, 2010

(51) Int. Cl. B44C 1/22; C23F 1/08

(52) U.S. Cl. 216/59; 156/345.25

(57) ABSTRACT

In accordance with an embodiment of the invention, a step in a fabrication process can be conducted so as to determine when the process has reached an end point. End point detection can be performed by detecting when a operating process condition changes. For example, in one embodiment, a step in a fabrication process (e.g., an etching step) can be conducted in a chamber by varying a position of a throttle valve connected to the chamber so as to maintain a desired pressure within the chamber. In such method, it can be determined when the etching step has reached an end point by detecting when a signal representative of the throttle valve position changes in a particular way which matches an expected signature. In another embodiment, a step in a fabrication process can be conducted in a chamber by maintaining a desired flow within the chamber, such as by controlling a throttle valve, and allowing the pressure within the chamber to vary. In such method, it can be determined when the step has reached an end point by detecting when a signal representative of the pressure changes. In a particular embodiment in which end point detection is based on change in pressure, the throttle valve can be maintained at a particular position when conducting the step in the fabrication process.

### BACKGROUND OF THE INVENTION

1. Field of the Invention

The subject matter of the present application relates to automatic control of a manufacturing process, for example, a method of automatically detecting an end point in a process used to remove material from a layer during fabrication of a microelectronic element.

2. Description of the Related Art

Microelectronic elements such as semiconductor chips typically are fabricated in form of a semiconductor wafer of 200 to 300 millimeters in diameter, after which the wafer is severed into a multiplicity of individual semiconductor chips. The fabrication of semiconductor chips requires forming internal metal wiring lines which extend horizontally within layers of dielectric material and vias which vertically connect wiring lines with other wiring lines or elements at another level of the chip. Semiconductor chip fabrication processes include deposition processes which add materials onto a surface of the wafer, as well as etching processes which remove exposed material that is exposed at the wafer surface. Metal wiring lines are often formed by a “damascene” process, in which a layer of dielectric material is deposited onto a wafer, after which a trench is etched in the dielectric layer, and then filled by depositing a metal therein. A via can be formed by forming an opening that extends downward from the unfilled trench through the dielectric layer to an underlying element, e.g., metal wiring line or metal silicide layer, and then filling the opening when depositing the metal that fills the trench.

The process of etching an opening for a via requires good control to etch completely through the dielectric material layer, but then stop when a portion of the underlying element becomes exposed. Stopping the etch process at the right time is especially important. Since the entire wafer undergoes the etching process simultaneously, the process must be performed in a way that assures that openings extend through the dielectric material layer throughout the area of the wafer, despite variations that may affect the thickness of the dielectric layer and the rate at which it is etched. However, the etching process must stop before it erodes the underlying element excessively. Sometimes, the underlying material layer is very thin, having a thickness of only a few tens of nanometers. Thus, the etch process faces a great challenge to simultaneously form openings which extend through a dielectric material layer throughout the area of the wafer, while avoiding underlying elements from eroding excessively.

In some fabrication processes, end point detection has been performed by optical emission spectroscopy. Emission spectroscopy can detect a variation in an intensity of a wavelength emitted by an effluent of a chemical mechanical polishing (CMP) process, which signals that a concentration of a component of the effluent has changed. For example, when forming metal wiring lines in semiconductor chips, a chemical mechanical polishing (CMP) process can be performed to remove a superfluous layer of metal above a dielectric layer in which the wiring lines are embedded. Because the metal layer and the dielectric layer have distinct chemical compositions, optical emission spectroscopy can detect when the dielectric layer becomes exposed by detecting a change in the intensity of a wavelength of light received from the effluent. A similar method can be employed for detecting an end point in an etch process.

Detecting such a change when etching via openings through a dielectric layer is particularly challenging. The surface of the metal layer exposed within each via opening can be rather small compared to the surface area of a wafer, causing the optical emission signal to be slight. Still further improvement is needed to address the challenge of end point detection when etching via openings in a dielectric layer.

### SUMMARY OF THE INVENTION

In accordance with an embodiment of the invention, a step in a fabrication process can be conducted so as to determine when the process has reached an end point. End point detection can be performed by detecting when a operating process condition changes. For example, in one embodiment, a fabrication process can be conducted in a chamber by varying a position of a throttle valve connected to the chamber so as to maintain a desired pressure within the chamber. In such method, it can be determined when the fabrication process has reached an end point by detecting when a signal representative of the throttle valve position changes.

For example, the step of determining that an end point is reached can include determining that the signal representing the throttle valve position changes in a way that matches an expected change. For example, the position of the throttle valve can be recorded as a function which varies with time. A characteristic of the function, for example, a shape of the function when graphed, i.e., when the function enters a particular regime, or the slope of the function, and any inflections therein can signal the occurrence of an endpoint with high confidence. In a particular example, the shape of the function being recorded or an inflection point therein during the current process can be compared with an expected signature to determine whether an endpoint has been reached. If a characteristic of the function matches the expected signature, then it is concluded that an endpoint has been reached. However, if the characteristic does not match the expected signature, then it can be concluded that an endpoint has not been reached.

The fabrication process may include an etching process that removes at least a portion of a second layer overlying a first layer, in which the first and second layers have different compositions. The step of detecting the end point can include detecting when the etching exposes at least a portion of the first layer.

In one embodiment, a first throttle valve position can be recorded while etching the layer and maintaining a pressure within the chamber at a desired value. In such embodiment, the step of detecting the end point can include detecting when a change in the position of the throttle valve from the first position matches an expected signature.

In a particular embodiment, the fabrication process can be conducted with the position of the throttle valve set to at least 35% open.

In accordance with another aspect of the invention, a method is provided for detecting an end point in a fabrication process. In such method, a fabrication process can be conducted in a chamber at a pressure that is subject to variation. For example, a throttle valve can be operated to maintain a desired flow between an interior and an exterior of the chamber. In one embodiment, the throttle valve can be maintained at a particular position. The method can further include generating a signal representative of the pressure within the chamber, and determining when the fabrication process has reached an end point by detecting a change in the signal.

In one embodiment, the step of determining when an end point is reached includes determining from the signal when a change in the pressure matches an expected signature.

In a particular embodiment, the fabrication process can include etching that removes at least a portion of a second layer overlying a first layer. The first and second layers can have different compositions. The determination of an end point can include detecting when the etching exposes at least a portion of the first layer.

One embodiment can include recording a first flow quantity between the interior and exterior of the chamber and a first pressure within the chamber while etching the layer with the throttle valve fixed in a first position. The fabrication process can be conducted as an etching process using the first flow quantity. The step of determining when an end point has been reached can include detecting when a change in the pressure from the first pressure matches an expected signature.

One embodiment can include recording a first position of the throttle valve while etching the layer and maintaining a pressure within the chamber at a first level. The fabrication process can be conducted as an etching process with the throttle valve set to the first position. The step of determining when an end point has been reached can include detecting when a change in the pressure from the first pressure matches an expected signature.

In a particular embodiment, the fabrication process wherein end point detection is based on detecting a change in chamber pressure, the fabrication process can be conducted with the position of the throttle valve set to at most 20% open.

Any and all of the foregoing methods can be controlled in accordance with an information processing system, i.e., the above-described control equipment having a processor operable to execute instructions. The execution of instructions by the processor can cause such method to be performed.

A computer-readable medium, e.g., any item which can be electronic (e.g., storage) or non-electronic (e.g., a disk) in nature, which can be read by a machine associated with a computer, and which has instructions recorded thereon, can be provided for causing any and all of the foregoing methods to be performed. For example, control equipment including a processor can utilize such computer-readable medium to read instructions from the medium and then execute such instructions to cause such method to be performed.

### BRIEF DESCRIPTION OF THE DRAWINGS

FIG. 1 is a schematic diagram illustrating an example semiconductor apparatus utilized in a method in accordance with an embodiment of the invention.

FIG. 2 is a flow diagram illustrating steps in a method in accordance with one embodiment of the invention.

FIG. 3 is a flow diagram illustrating steps in a method in accordance with a variation of the embodiment illustrated in FIG. 2.

FIG. 4 is a flow diagram illustrating steps in a method in accordance with one embodiment of the invention.

FIG. 5 is a flow diagram illustrating steps in a method in accordance with a variation of the embodiment illustrated in FIG. 4.

### DETAILED DESCRIPTION

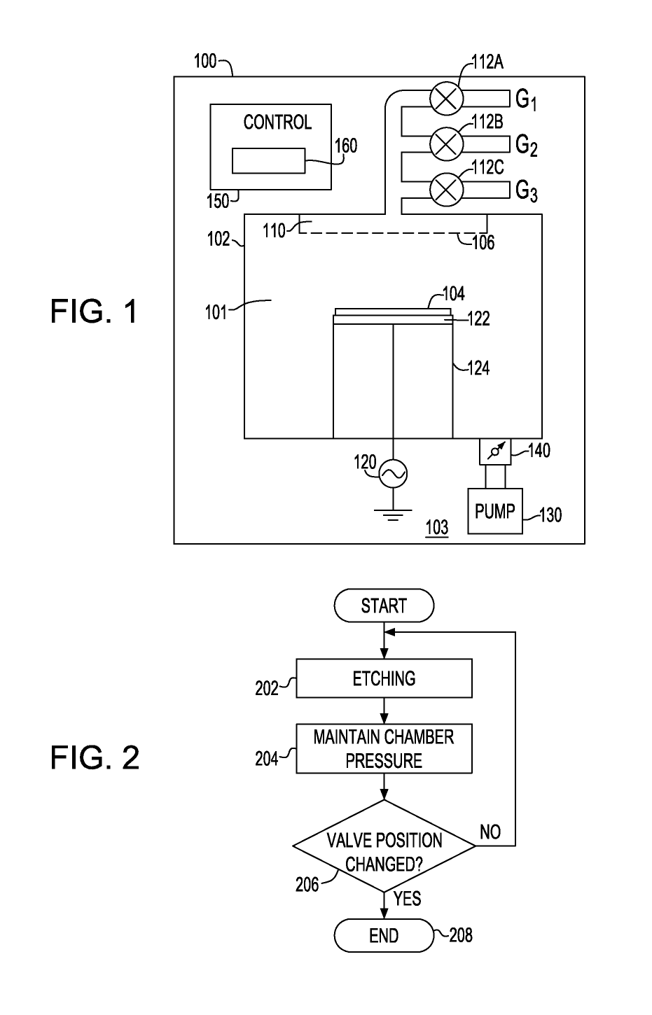

An example of a semiconductor processing apparatus 100 is illustrated in FIG. 1, on which semiconductor fabrication methods disclosed herein can be practiced. As seen in FIG. 1, the processing apparatus can include a chamber 102 in which a wafer 104 can be positioned within a flow of a fluid distributed through manifold 110 and a showerhead 106. A supply of gases to the chamber is depicted by tube 108 which collects gases G1, G2, and G3, the flow of which can be individually controlled by valves 112A, 112B, and 112C. The processing apparatus can include a radio frequency (RF) generator 120 having an oscillator and amplifier operable to create a plasma under controlled conditions. In one example, the RF generator 120 can generate a frequency of 13.56 megahertz, which is commonly used for generating plasma within semiconductor processing equipment. As further seen in FIG. 1, the wafer 104 can be held in position within the chamber by a chuck 122, which in turn, can be supported on a pedestal 124 for transferring heat to or from the wafer.

A pump 130 can be connected to the chamber 100 via a throttle valve 140 for expelling gases and other material from the chamber, e.g., an effluent from a process. The pump 130 can evacuate gases from the chamber so as to create a negative pressure within an interior 101 of the chamber relative to the exterior 103. The throttle valve 140 typically has many different positions between a fully closed position and a fully open position. In one example, the position of the throttle valve may be continuously variable between the fully closed and fully open positions. The throttle valve can be used to establish a rate at which a fluid, e.g., the effluent, flows between an interior 101 of the chamber 100 and an exterior 103 thereof. When conducting a fabrication process, the throttle valve may need to change from one position to another to maintain a given pressure within the chamber. This can happen because the rate of reaction can vary during the fabrication process. In a particular example when conducting a process of etching via openings in a dielectric layer, the rate of reaction can vary when the etching process punches through the dielectric layer and exposes portions of conducting or semiconducting elements below the layer. For example, the throttle valve position can change in a detectable and predictable way when an etching process exposes portions of the elements underlying the dielectric layer within the via openings.

On the other hand, if one seeks to maintain a certain rate of flow through the throttle valve, then the pressure within the chamber may be forced to change from one value to another due to variation in the rate of reaction. For example, the pressure can transition from one value to another value in a detectable and predictable way when an etching process exposes portions of elements underlying the dielectric layer within the via openings.

Equipment for controlling various operating parameters of the processing apparatus is depicted at 150. Such equipment 150 can include, for example, a processor 160 and a plurality of instructions which are executable by the processor to control the operation of the flow control valves 112A, 112B, 112C, RF generator 120, pump 130, and throttle valve 140, as well as other processing conditions, such as a temperature of pedestal 124. The equipment may control operating parameters through wiring or other means (not shown). Such control can be performed automatically by the processor executing instructions of a control program based on signals received from sensor devices which sense real-time conditions within the chamber. A device can generate a signal indicating the position of the throttle valve for example, and such signal can be received by the processor 160. As either wired and wireless means may be used to transmit signals from the sensor devices, the particular transmission means is assumed present, although it has not been shown. Likewise, either wired or wireless means may be used to transmit signals from the processor 160 to control the operation of the flow valves 112A, 112B, and 112C, RF generator 120, and throttle valve 140, and such means is also assumed present, although not explicitly shown in FIG. 1. For example, the processor can transmit a signal which controls an actuator that changes the throttle valve so as to increase or reduce the flow rate of gases between an interior and an exterior of the chamber. The control equipment 150 can include storage in which executable instructions can be stored for performing a method in accordance with an embodiment of an invention herein. In one example, the control equipment 150 can include an interface for reading, writing or doing both from a computer-readable recording medium on which instructions can be stored for performing a method in accordance with an embodiment of an invention herein.

A method of conducting a fabrication process according to an embodiment of the invention will now be described. Referring to FIG. 2, processing apparatus such as, for example, the above-described apparatus 100 (FIG. 1) can be used to conduct a step in a fabrication process. In a particular example, the step can be a reactive ion etch process (step 202) used to etch openings in a dielectric layer to at least partially expose conductive or semiconducting elements underlying the dielectric layer. The step in the fabrication process (e.g., an etching step) can be performed while maintaining a desired pressure within the chamber (step 204), which makes the throttle valve subject to change between positions. During the step, a signal is generated which is representative of a position of the throttle valve. A processor 160 (FIG. 1) can monitor the signal and determine when a position of the throttle valve changes (step 206). When the signal changes, it can indicate a change in the throttle valve position.

Thus, by monitoring the signal and detecting a change in the signal, it can be determined when the step in the fabrication process has reached an end point. A characteristic change in the throttle valve position can indicate a change in the reaction rate that accompanies the exposing of the metal or semiconducting elements below the dielectric layer. In one example, the step of determining that an end point is reached can include determining from the signal when the position of the throttle valve changes in a way that matches an expected change. For example, the position of the throttle valve can be recorded as a function which varies with time. A characteristic of the function, for example, a shape of the function when graphed, i.e., when the function enters a particular regime, or the slope of the function, and any inflections therein can signal the occurrence of an endpoint with high confidence. The shape of the function being recorded during the step in the fabrication process can be compared with an expected signature to determine whether an endpoint has been reached. If a characteristic of the function matches the expected signature, then it is concluded that an endpoint has been reached. However, if the characteristic does not match the expected signature, then it is concluded that an endpoint has not been reached. Thus, upon detecting an expected change in the throttle valve position signal which matches an expected signature, an end point can be determined. The control function can then bring the etching step to an end 208.

In this embodiment, it can be expected that the change in the throttle valve position would be more easily noticed if the change in position is a relatively large one. For example, for a throttle valve whose position can be continuously varied between a fully closed, 0% open position and a fully open, 100% open position, the change in position may be more easily noticed when the step is conducted with the throttle valve set to a relatively open position. When the throttle valve position is relatively open, the throttle valve position must change to a substantial degree to maintain a desired pressure within the chamber. This can be the case even when the relatively large change in the throttle valve position would only compensate for a relatively small change in pressure. The reason for such operation can be understood as follows. When the valve is only 10% open, a 30% change in the degree of openness only moves the throttle valve to a 7% open position, or alternatively, a 13% open position. It may be difficult to detect an end point in processing from these changes in the valve position when variations in the valve position and signal noise are comparable.

On the other hand, when the valve begins from a 35% open position, a 30% change in the degree of openness moves the throttle valve to a 25% open position, or alternatively, a 45% open position. It may be easier to detect these larger changes in the throttle valve position when other variations in the valve position that do not represent end points are smaller. In addition, it may be expected that when the throttle valve is relatively open (e.g., about 35% open or more), then a relatively small change in the pressure will cause a significantly larger change in the rate of flow of gases than when the throttle valve is relative closed (e.g., less than about 35% open).

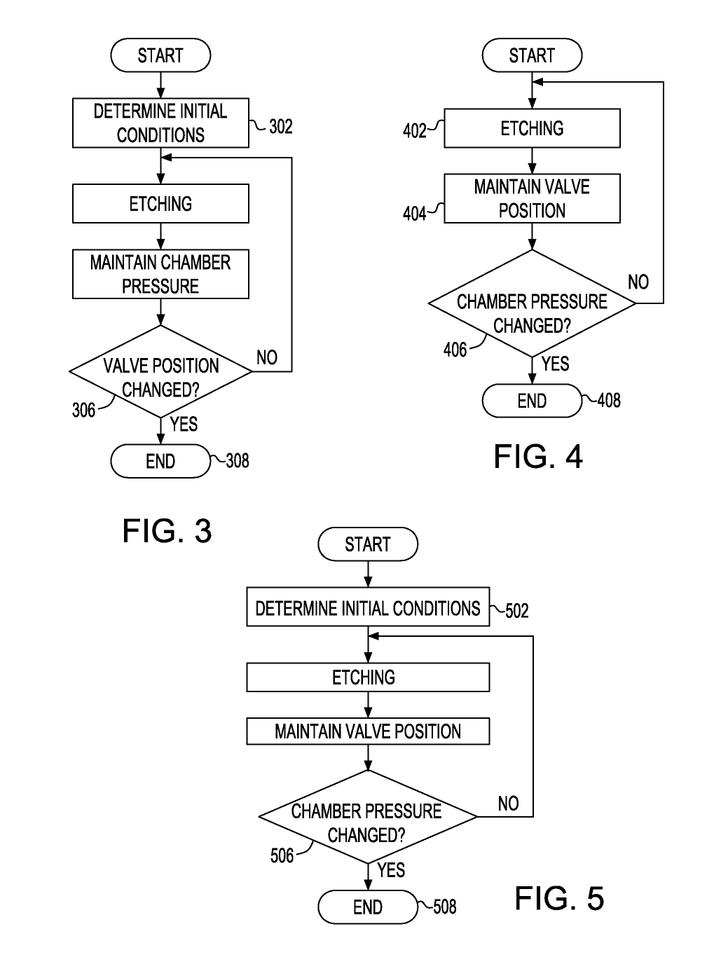

FIG. 3 illustrates a variation of the above-described embodiment (FIG. 2) which is the same as that process except that it includes a further step (302) to determine one or more initial conditions at the start of the etching process. For example, the position of the throttle valve can be fixed at a desired position, beginning the etching process, and then allowing the pressure of the chamber to settle at a value at which the etching process will be conducted. The initial pressure value, with the throttle valve at the desired position, then is recorded as an “initial” pressure. A gas flow within the chamber, a temperature or one or more other conditions which affect the etching step may also be determined and recorded at this time. The method can then proceed in the same manner as described above (FIG. 1). In this embodiment, the end point of the etching step can be determined, for example, in relation to the recorded initial position of the throttle valve.

Referring to FIG. 4, in another embodiment provides detection of an end point based upon a change in pressure within the chamber, rather than a change in the throttle valve position. In this case, the throttle valve is fixed at a desired position to allow a desired flow of gas between the interior 101 (FIG. 1) and the exterior 103 of the chamber 102. This results in a desired flow of gas to the surface of the wafer 104. Processing, e.g., etching (402) of the wafer can then begin. In addition to a flow of gases (e.g., G1, G2, G3) to the chamber, the power from RF generator 120 and other conditions, e.g., temperature, can be set for conducting a fabrication process, such as, for example, a reactive ion etch process. A reactive ion etch process can be used to etch a dielectric layer of the wafer to form via openings, for example. During the etching step, the pressure is allowed to vary, in order to produce and maintain the desired flow. In a particular embodiment, the throttle valve can be fixed at one position (i.e., the same degree of openness) (404) during the etching step. Alternatively, the position of the throttle valve may vary somewhat with time to produce and maintain the desired flow of gas.

In such embodiment, it can be determined that an end point in the step of the fabrication process has been reached when the pressure within the chamber changes in a way that matches an expected signature (406). For example, the pressure can be recorded as a function in which the pressure varies relative to time. A characteristic of the function, for example, a shape of the function when graphed, i.e., when the function enters a particular regime, or the slope of the function, and any inflections therein, can signal the occurrence of an endpoint with high confidence. The shape of the function being recorded during the current process can be compared with an expected signature to determine whether an endpoint has been reached. If a characteristic of the function matches the expected signature, then it is concluded that an endpoint has been reached. However, if the characteristic does not match the expected signature, then it is concluded that an endpoint has not been reached. Thus, upon detecting an expected change in the pressure which matches an expected signature, an end point can be determined. At that time, the control function 160 (FIG. 1) can then bring the etching step to an end (408).

The control function 160 may then alter conditions within the chamber so as to transition to a subsequent processing step of the fabrication process. The subsequent processing step could also be an etching step, or a step other than an etching step. For example, the control function 160 can operate process control equipment 150 so as to stop the etching step by ending or reducing a flow of reactive gas within the chamber, or by increasing a flow of inactive gas.

In this embodiment, it can be expected that the change in the pressure would be more easily noticed if the change is relatively large. With the throttle valve maintained at a particular position, a pressure change can occur when the etching process exposes underlying conductive or semiconducting elements below the dielectric layer. At that time, the gases in the chamber can react with the underlying elements and can cause reaction products to increase or decrease. This, in turn, can cause the pressure within the chamber to vary in an expected way that can be compared to a signature to determine whether or not an end point has been reached.

The pressure can be expected to change by a larger amount when the throttle valve is in a mostly closed position. For a throttle valve whose position can be continuously varied between a fully closed, 0% open position and a fully open, 100% open position, the change in position may be more easily noticed when the step in the fabrication process is conducted with the throttle valve set to mostly closed, e.g., a position about 35% open or less. In a particular embodiment, the throttle valve is maintained at a position of 20% open or less, and in one example, can be set to a position which is 10% to 20% open. When the throttle valve is in a mostly closed position, the pressure can change by a substantial degree during the step in the fabrication process.

FIG. 5 illustrates a variation of the above-described embodiment (FIG. 4) which is the same as that process except that it includes a further step (502) to determine and record one or more “initial conditions” at the start of an etching step. For example, the action of determining and recording an initial pressure can be performed each time a wafer is placed in the chamber to be processed. In that way, a change in chamber conditions or variation between wafers can be compensated when going from one wafer to the next wafer. The initial pressure level can be one at which the chamber settles when conducting the etching step. A position of the throttle valve, a temperature or one or more other conditions which affect the etching step may also be determined and recorded at this time. The method can then proceed in the same manner as described above (FIG. 1).

For example, in one embodiment, when the initial chamber pressure is a value such as 30 milliTorr, an end point can be detected whenever an increase in the pressure to 45 milliTorr is detected within a period of five seconds. Alternatively, in another embodiment, an end point can be detected when a decrease in the pressure is detected, for example, from 30 milliTorr to 20 milliTorr in a span of 10 seconds. The pressure values and rates of increase or decrease are merely illustrative. End point detection may be possible with a smaller change in pressure, or a greater change may be required. Moreover, the regime (e.g., low pressure, tens of milliTorr range, or higher pressure regime) at which the etching process is performed can affect the shape, slope or inflection point of the function (pressure versus time) which can be monitored to determine an end point, such that an end point can be detected upon a smaller or greater change in the pressure.

Any and all of the foregoing methods can be controlled in accordance with an information processing system, i.e., the above-described control equipment having a processor operable to execute instructions which cause such method to be performed using processing equipment as described above.

A computer-readable medium, e.g., any item which can be electronic (e.g., storage) or non-electronic (e.g., a disk) in nature, which can be read by a machine associated with a computer, and which has instructions recorded thereon, can be provided for causing any and all of the foregoing methods to be performed. For example, the above-described control equipment can utilize such computer-readable medium to read instructions which are executable by a processor therein to cause such method to be performed.

While the invention has been described in accordance with certain preferred embodiments thereof, those skilled in the art will understand the many modifications and enhancements which can be made thereto without departing from the true scope and spirit of the invention, which is limited only by the claims appended below.

1. A method, comprising:
a) conducting at least a step in a fabrication process in a processing chamber by varying a position of a throttle valve with time to thereby maintain a desired pressure within the chamber;
b) generating a signal representative of the position of the throttle valve; and
c) determining when the step in the fabrication process has reached an end point by detecting a change in the signal.

2. A method as claimed in claim 1, wherein step (c) includes determining from the signal when a change in the position of the throttle valve matches an expected signature.

3. A method as claimed in claim 2, wherein step (a) includes etching that removes at least a portion of a second layer overlying a first layer, the first and second layers having different compositions, and step (c) includes detecting when the etching exposes at least a portion of the first layer.

4. A method as claimed in claim 2, wherein step (a) includes conducting the step in the fabrication process with the position of the throttle valve set to at least 35% open.

5. A method as claimed in claim 3, further comprising, prior to step (a), recording a first flow quantity between the interior and exterior of the chamber and a first pressure within the chamber while etching the layer with the throttle valve fixed in a first position, wherein step (a) includes conducting the etching process using the first flow quantity and while maintaining the pressure within the chamber at the first pressure value, wherein step (c) includes detecting when a change in the position of the throttle valve matches an expected signature.

6. A method as claimed in claim 5, wherein step (b) includes recording the position of the throttle valve as a function relative to time, and step (c) includes determining when a shape of the function matches an expected signature.

7. A method as claimed in claim 5, wherein step (b) includes recording the position of the throttle valve as a function relative to time, and step (c) includes determining when a slope of the function matches an expected signature.

8. A method as claimed in claim 5, wherein step (b) includes recording the position of the throttle valve as a function relative to time, and step (c) includes determining when an inflection of the function matches an expected signature.

9. A computer-readable recording medium having instructions recorded thereon, the instructions being executable by a processor to perform a method as claimed in claim 1.

10. An information processing system comprising:
a processor; and
instructions executable by the processor to perform a method as claimed in claim 1.

11. A method, comprising:
a) conducting a step in a fabrication process in a chamber at a pressure subject to variation by setting a throttle valve to a fixed position;
b) generating a signal representative of the pressure within the chamber; and
c) determining when the step in the fabrication process has reached an end point by detecting a change in the signal.

12. A method as claimed in claim 11, wherein step (c) includes determining from the signal when a change in the pressure matches an expected signature.

13. A method as claimed in claim 12, wherein step (a) includes etching that removes at least a portion of a second layer overlying a first layer, the first and second layers having different compositions, and the determining of an end point in step (c) coincides with a time when the etching exposes at least a portion of the first layer.

14. A method as claimed in claim 12, wherein step (a) includes conducting the step in the fabrication process with the position of the throttle valve set to at most 20% open.

15. A method as claimed in claim 13, further comprising, prior to step (a), recording a first flow quantity between the interior and exterior of the chamber and a first pressure within the chamber while etching the layer while the throttle valve is fixed in a first position, wherein step (a) includes conducting the etching process using the first flow quantity, and step (c) includes detecting when a change in the pressure from the first pressure matches an expected signature.

16. A method as claimed in claim 13, further comprising, prior to step (a), recording a first value of the pressure while maintaining the position of the throttle valve fixed in a first position and etching the layer, wherein step (a) includes conducting the etching step with the throttle valve fixed in the first position, and step (c) includes detecting when a change in the pressure from the first value matches an expected signature.

17. A method as claimed in claim 16, wherein step (b) includes recording the pressure as a function relative to time, and step (c) includes determining when a shape of the function matches an expected signature.

18. A method as claimed in claim 16, wherein step (b) includes recording the pressure as a function relative to time, and step (c) includes determining when a slope of the function matches an expected signature.

19. A computer-readable recording medium having instructions recorded thereon, the instructions being executable by a processor to perform a method as claimed in claim 11.

20. An information processing system comprising:
a processor; and
instructions executable by the processor to perform a method as claimed in claim 11.
